(19) United States
(12) Patent Application Publication
(10) Pub. No.: US 2011/0151044 A1
(43) Pub. Date: Jun. 23, 2011

(54) PRESS WORKING SYSTEM

(75) Inventors: Masatoshi Kato, Tokyo (JP); Hirotaka Kosugi, Tokyo (JP); Hiroki Kobayashi, Tokyo (JP); Seiichi Hasegawa, Tokyo (JP); Katsuhiko Shimamura, Tokyo (JP); Jiro Okazaki, Tokyo (JP); Susumu Kondou, Tokyo (JP); Tsutomu Tanaka, Tokyo (JP)

(73) Assignee: HONDA MOTOR CO., LTD., Tokyo (JP)

(21) Appl. No.: 13/059,802

(22) PCT Filed: Aug. 27, 2009
(86) PCT No.: PCT/JP2009/064943

§ 371 Date: Mar. 7, 2011

(30) Foreign Application Priority Data
Aug. 29, 2008 (JP) 2008-222940
Aug. 29, 2008 (JP) 2008-222941
Aug. 29, 2008 (JP) 2008-222942

(51) Int. Cl. B29C 33/30

(52) U.S. Cl. 425/183

(57) ABSTRACT

A press working system, wherein a die can be replaced in a short time. A press working system (1) is provided with a press body having press machines (P1-P4) for producing an industrial product by pressing a plate-like member, and also with a moving bolster (MB) for moving dies (M) which are respectively provided inside the press machines (P1-P4) and stowing the dies (M) into die stowage chambers (13). The die stowage chambers (13) are arranged as a pair on both the left and right sides of a line extending in the longitudinal direction of the press body.

### TECHNICAL FIELD

The present invention relates to a press working system.

### BACKGROUND ART

Conventionally, a press working system of a configuration in which a plurality of press machines aligned in a line and carries out sequential processing on works is known. In this conventional press working system, each mold used in each press machine is discharged to one side of each press machine (one side setting the line on which each press machine is aligned therebetween), in a case of the type of molds used in press working being changed in response to the type of plate member being processed changing.

In addition, a mold conveying system is provided to this conventional press working system. This mold conveying system includes a mold hangar that stores the molds expected to be used by each press machine, a mold conveying cart and ancillary equipment such as an overhead crane. The molds stored in the mold hangar are transferred from the mold hangar to the mold conveying cart using ancillary equipment, are conveyed to a mold maintenance area by the mold conveying cart, and maintenance work on the molds is done in this mold maintenance area. The molds on which this maintenance has been done are stored again in the mold hangar by the mold conveying cart and ancillary equipment.

In addition, with this conventional press working system, in a case of storing in the mold hangar a mold removed and discharged from a press machine in order to exchange the mold, the mold discharged from the press machine is first transferred to a traverser using an electric crane. Then, the mold placed on the traverser is stored in the mold hangar using a stacker crane. It should be noted that a traverser or the like is similarly used also when supplying a mold from the mold hangar to a press machine.

In addition, Patent Documents 1 to 3 are given as existing patent documents related to the field, for example.

Patent Document 1: Japanese Unexamined Patent Application Publication No. H8-90101

Patent Document 2: Japanese Unexamined Patent Application Publication No. H9-169032

Patent Document 3: Japanese Unexamined Utility Model Registration Application Publication No. H6-39223

### DISCLOSURE OF THE INVENTION

### Problems to be Solved by the Invention

However, with the conventional press working system, since each mold is discharged to the side of the mold hangar (in the same direction), which is provided to one side of each press machine, when exchanging each mold, there is a problem in that time is consumed in the exchanging of molds. In other words, since four sets of molds (four upper molds and four lower molds, totaling eight molds) in a four press machine installation are discharged substantially simultaneously to one side of the press machines, time is consumed in the processing of each discharged mold, and thus a long time becomes necessary in off-line setup. As processing of the molds, the processing for storing each mold discharged from a press machine in the mold hangar can be given, for example.

If a long time is necessary in the exchanging of molds, a situation may arise in which there is not enough time for preparation of the molds when the mold exchange frequency rises, and thus the press working by the press machines must be temporarily interrupted.

In addition, since ancillary equipment such as an overhead crane is used in the mold conveying system of the conventional press working system, there is a problem in that the installation area of the press working system is large.

Moreover, the molds removed and discharged from the press machines in the conventional press working system are stored in a mold hangar, upon being placed in a traverser using an electric crane. As a result, ancillary equipment such as an electric crane and traverser are necessary, and thus the overall facility becomes massive.

Consequently, a first object of the present invention is to provide a press working system that can shorten the mold exchanging time.

Furthermore, a second object of the present invention is to provide a press working system that can make the installation area thereof small.

Moreover, a third object of the present invention is to provide a press working system that can make the overall facility compact.

### Means for Solving the Problems

The present invention relates to a press working system including a press main body having a plurality of press machines that press work a plate member to produce an industrial product; and a moving bolster that causes a mold equipped inside of each of the plurality of press machines to move and be stored in a mold hangar, in which the mold hangar is disposed as a pair at both sides of the press main body about a longitudinal direction thereof.

In addition, it is preferable for a pair of the mold hangars to have a plurality of mold storage rooms that three-dimensionally stores a plurality of molds.

Moreover, it is preferable for a pair of the mold hangars to have a stacker crane at a center inside thereof that is movable in two dimensions, and have a structure in which a plurality of mold storage rooms is disposed two-dimensionally on both sides about the stacker crane.

Furthermore, it is preferable for the mold to move between inside of the press machine and inside the mold hangar in a state installed on the moving bolster.

The present invention is related to a press working system including a press main body having a plurality of press machines that press work a plate member to produce an industrial product, and having a configuration that causes molds provided inside of the plurality of press machines to move and stores the mold in a mold hangar, in which, when the mold is stored in the mold hangar or carried out therefrom, a mold conveying cart is made to directly enter inside of the mold hangar, to store the mold inside of the mold hangar or to carry the mold out from the mold hangar.

In addition, it is preferable for the mold hangar to have a plurality of mold storage rooms that stores a plurality of molds three-dimensionally.

Moreover, it is preferable for transfer of the mold between the mold conveying cart and the mold hangar to be performed by a stacker crane disposed inside of the mold hangar.

Furthermore, it is preferable for the stacker crane to have a function of being able to freely transfer the mold into a plurality of mold storage rooms disposed three-dimensionally at a periphery of the stacker crane.

The present invention relates to a press working system including a press machine that conducts press working on a work using a mold installed on a moving bolster, and a mold hangar that can store a plurality of molds, in which the press working system comprises a mechanism that allows a mold and moving bolster used in the press machine to freely move between inside of the mold hangar and the press machine, and a mold separating device causing the mold and the moving bolster to separate is provided inside of the mold hangar.

In addition, it is preferable for a mold transfer device that can change a storage position of a mold three-dimensionally to be provided to the mold hangar.

Moreover, it is preferable for the mold separating device to have a mold lifting member that operates in an up-down direction by way of hydraulics or electric power.

Furthermore, it is preferable for at least two self-propelled moving bolsters to be disposed to be able to enter and exit from the press machine.

### Effects of the Invention

According to the press working system of the present invention, it is possible to shorten the exchanging time of molds.

In addition, according to the press working system of the present invention, the installation area can be configured to be small.

Moreover, according to the press working system of the present invention, the overall facility can be configured to be compact, since ancillary equipment such as an electric crane and traverser are not required. In addition, since the time required in the exchange of molds can be shortened, the rate of operation of the press working system can be improved.

### BRIEF DESCRIPTION OF THE DRAWINGS

FIG. 1 is a plan view showing a schematic configuration of a press working system;

FIG. 2 is a fragmentary view taken in the direction of the arrows II-II in FIG. 1;

FIG. 3 is an enlarged view of the V portion in FIG. 2;

FIGS. 4A to 4C are a diagram showing each step in a case of transferring a mold M in a mold exchanging station ST2;

FIGS. 5D to 5F are a diagram showing each step in a case of transferring a mold M in a mold exchanging station ST2;

FIGS. 6A to 6C are a diagram showing each step in a case of transferring a mold M in a mold receiving station ST3; and

FIG. 7 is a plan view of a press working system provided with a traverser TV.

### EXPLANATION OF REFERENCE OUT THE INVENTION

1 press working system

13 mold hangar

17 rail

21 mold conveying cart

23 mold storage room

25 stacker crane

M mold

MB moving bolster

P1, P2, P3, P4 press machine

ST2 mold exchanging station

ST3 mold receiving station

### PREFERRED MODE FOR CARRYING OUT THE INVENTION

Hereinafter, a preferred embodiment of a press working system 1 of the present invention will be explained based on the drawings.

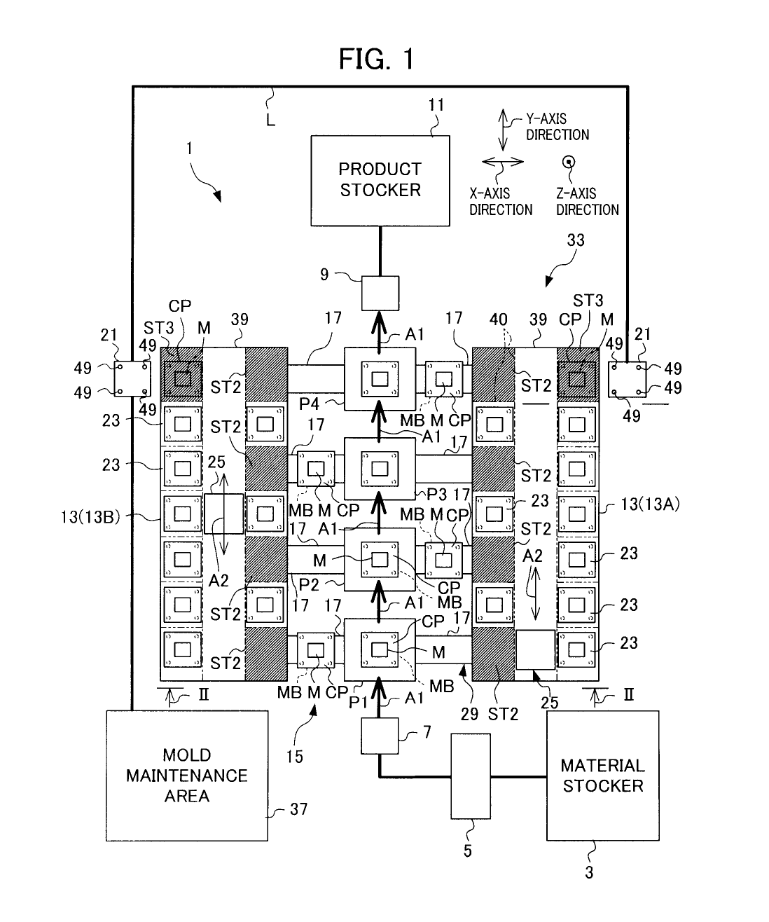

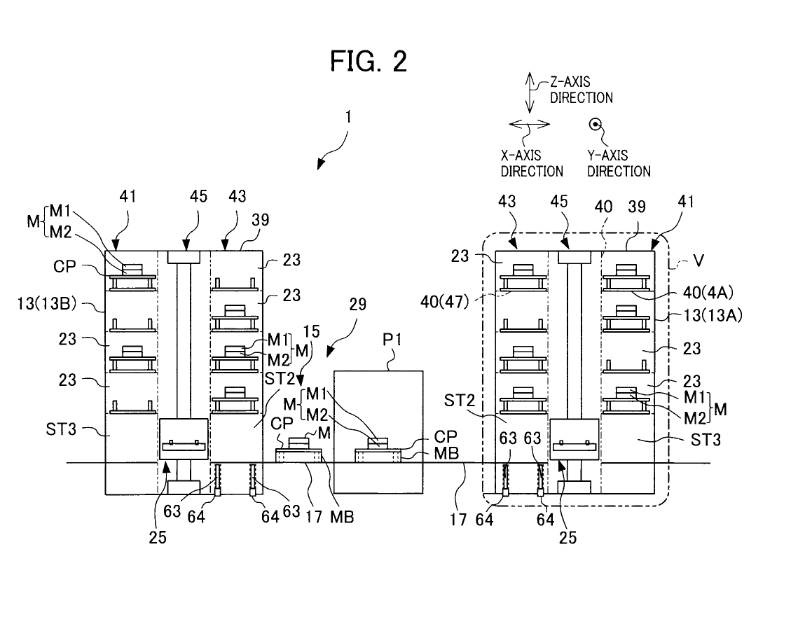

First, an overall configuration of the press working system 1 of the present invention will be explained while referring to FIGS. 1 and 2.

FIG. 1 is a plan view showing a schematic configuration of the press working system 1 according to an embodiment of the present invention, and FIG. 2 is a fragmentary view taken in the direction of the arrows II-II in FIG. 1.

It should be noted that the horizontal direction is defined as the X-axis direction, a direction that is another horizontal direction perpendicular to the X-axis direction is defined as the Y-axis direction, and the vertical direction (up-down direction) is defined as the Z-axis direction, for convenience of explanation.

As shown in FIG. 1, the press working system 1 includes a press main body configured from a plurality of press machines (four in FIG. 1) P1, P2, P3 and P4, which are aligned in a linear arrangement placed at predetermined intervals in the Y-axis direction, and using the plurality of press machines P1 to P4 configuring this press main body, conducts press working in order on a plate member such as a plate-shaped work configured by a metal such as steel to produce an industrial product (or semiprocessed product).

The press working system 1 includes a material stocker 3, a material cutting device 5, a work supply device 7, a work conveying device (not illustrated), a product carrying device 9, a product stocker 11, mold hangars 13 (13A, 13B), moving bolsters MB, rails 17, a mold conveying cart 21, and a mold maintenance area 37.

The material stocker 3 stocks material, and is made so that this material being stocked is supplied to the material cutting device 5 one by one by a supply device, which is not illustrated, and is cut into works of a predetermined size. The works thus cut are supplied one by one (as sheets) to the press machine P1 by the work supply device 7, conveyed in the direction indicated by each arrow A1 in FIG. 1 by each work conveying device (work conveying devices configured by robots or the like) not illustrated, and press worked by passing through each press machine P1 to P4 in order. After predetermined quality inspection has been carried out for the quality of the products press worked, the works (products) thus press worked by each of the press machines P1 to P4 are transported to the product stocker 11 by the product carrying device 9, and stored in the product stocker 11. As this product carrying device 9, a remote control push car or automated guide vehicle (hereinafter referred to as AGV) is used, for example.

Each of the press machines P1 to P4 is arranged by placing at a predetermined interval, for example, along a conveyor line of works (trajectory on which the works are conveyed, e.g., line that is a straight line extending in the up-down direction in FIG. 1 passing through each arrow A1 in FIG. 1), and is made so as to perform press working using a mold M installed on a moving bolster MB.

The aforementioned work conveying device is a device that linearly and intermittently conveys works along the work conveyor line when sequential working is conducted on works by each of the press machines P1 to P4.

The mold hangars 13 store a plurality of the molds (molds detached from the moving bolsters MB) M used by each of the press machines P1 to P4, and are provided at two places on both left and right sides of the respective press machines P1 to P4.

In other words, a first mold hangar 13A is provided to be separated by a predetermined distance from each of the press machines P1 to P4 on one side (right side in FIG. 1) of each of the press machines P1 to P4, with the work conveyor line set therebetween. A second mold hangar 13B is provided to be separated by a predetermined distance from each of the press machines P1 to P4 on the other side (left side in FIG. 1) of each of the press machines P1 to P4, with the work conveyor line set therebetween.

The rails 17 are arranged between each of the press machines P1 to P4 and the first mold hangar 13A, and between each of the press machines P1 to P4 and the second mold hangar 13B. The rails 17 are provided in a linear arrangement along the X-axis direction.

The moving bolsters MB have a self-propulsion function, and one is arranged on the first mold hangar 13A side of each of the press machines P1 to P4, respectively, and on the second mold hangar 13B side of each of the press machines P1 to P4, respectively. In other words, a total of eight moving bolsters are arranged at the four press machines P1 to P4 in the present embodiment.

These moving bolsters MB are arranged on all of the rails 17, and are made to be moveable by self propulsion between the press machines P1 to P4 and the first mold hangar 13A, or between the press machines P1 to P4 and the second mold hangar 13B.

More specifically, the moving bolsters MB arranged on the first mold hangar 13A side of the press machines P1 to P4 move between the press machines P1 to P4 and the first mold hangar 13A, and the moving bolsters MB arranged on the second mold hangar 13B side of the press machines P1 to P4 move between the press machines P1 to P4 and the second mold hangar 13B.

For example, in a state in which the mold M used by the press machine P1 has been set on the top surface of the moving bolster MB arranged on the first mold hangar 13A side of the press machine P1, the moving bolster MB moves from the press machine P1 to a mold exchanging station ST2 described later that is provided in the first mold hangar 13A, and carries the mold M out.

In addition, in a state in which the mold M used by the press machine P1 is set on the top surface in the mold exchanging station ST2, the moving bolster MB moves from the mold exchanging station ST2 to the press machine P1, and supplies the mold M to this press machine P1.

Similarly, in a state in which the mold M used by the press machine 1 has been set on the top surface of the moving bolster MB arranged on the second mold hangar 13B side of the press machine P1, the moving bolster MB moves from the press machine P1 to a mold exchanging station ST2 that is provided in the second mold hangar 13B, and carries the mold M out.

In addition, in a state in which the mold M used by the press machine P1 is set on the top surface in the mold exchanging station ST2, the moving bolster MB moves from the mold exchanging station ST2 to the press machine P1, and supplies the mold M to this press machine P1.

It should be noted that the moving bolster MB is fixed to the press machine P1 in a state in which the mold M is placed on the top surface thereof, and is used in the press working.

More specifically, the mold M is placed on the moving bolster MB via a common plate CP of a rectangular plate shape, as shown in FIG. 2. Explaining in more detail, a lower mold M2 is installed at a predetermined position of the common plate CP and fixed to the common plate CP using a fastening means such as a bolt. The common plate CP is positioned on the moving bolster MB of a rectangular plate shape and installed using a clamp (not illustrated) or the like.

It should be noted that, when the moving bolsters MB and molds M are placed on the press machines P1 to P4, the moving bolsters MB are configured so as to installed and positioned at predetermined positions of the bed of the press machines P1 to P4 using a clamp or the like, and further, to be automatically fixed to the bed by an actuator such as a hydraulic cylinder. In addition, the upper mold M1 is configured so as to be positioned at a predetermined position of a slider of the press machines P1 to P4 using a clamp or the like, and further, to be automatically fixed by an actuator such as a hydraulic cylinder.

In this way, the moving bolsters MB are disposed on both sides of the press machines P1 to P4 in the present embodiment.

With this, in a case of exchanging the mold installed to the press machines P1 to P4, there molds are discharged to be distributed to the first mold hanger 13A side and second mold hanger 13B side.

In other words, as shown in FIG. 1, for example, in a case of causing the molds and moving bolsters MB installed in the press machine P1 and the press machine P3 to discharge to the second mold hangar 13B side, the mold and moving bolster MB installed in the press machine P2 and press machine P4 are made to discharge to the first mold hangar 13A side.

Consequently, discharging all of the molds to the mold hangar 13 on one side is prevented, and thus the burden of mold exchanging on the mold hangars 13 can be eliminated, and the time required in mold exchanging can be shortened.

In addition, in a situation in which the mold and moving bolster MB are discharged to one side of the press machines P1 to P4, the moving bolster MB on which the mold to be used next is installed can be installed on the press machine from the other side. Consequently, it is possible to further shorten the time required in mold exchanging.

It should be noted that, in the supply and discharge of the mold M and the moving bolster MB to the press machines P1 to P4 (exchange of the mold M in the press machines) is configured so as to be done in a state in which conveying of the work is not done by the work conveying device described earlier, and the work is not present in the press working system 1.

The mold conveying cart 21 moves between a mold receiving station ST3 described later that is provided inside the mold hangar 13, and a mold maintenance area 37 along a conveyor line L.

More specifically, the mold receiving station ST3 is configured to be able to be entered by the mold conveying cart 21, and a mold M stored in the mold hangar 13 is placed on the mold conveying cart 21 that has entered the mold receiving station ST3. Thereafter, the mold conveying cart 21 on which the mold M has been placed moves along the conveyor line L and conveys the mold M to the mold maintenance area.

In addition, the mold conveying cart 21 conveys a mold M maintained in the mold maintenance area 37 to the mold receiving station ST3.

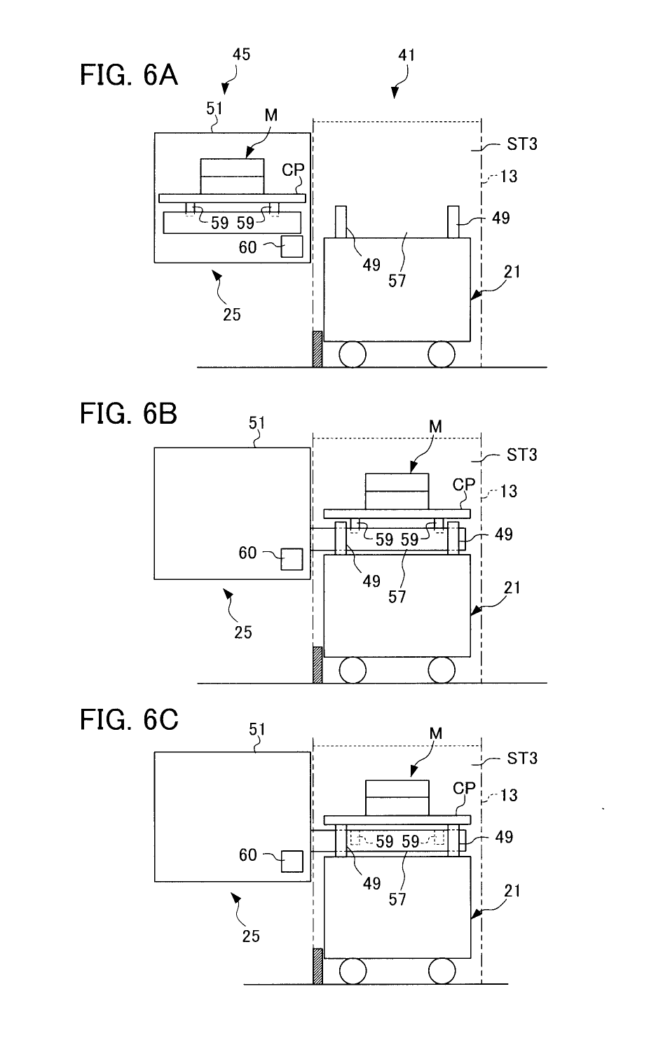

Four mold placement bodies 49 of cylindrical shape are provided on the top surface of the mold conveying cart 21 (refer to FIGS. 1 and 6).

A remote control push car, AVG or the like can be suitably employed as the mold conveying cart 21.

It should be noted that the mold conveying cart 21 can perform conveyance of the mold M not only between the mold hangars 13 and the mold maintenance area 37, but also between the first mold hangar 13A and the second mold hangar 13B.

Maintenance on a mold M that has been damaged, worn, or the like is performed in the mold maintenance area 37.

Next, the details of the mold hangars 13 will be explained.

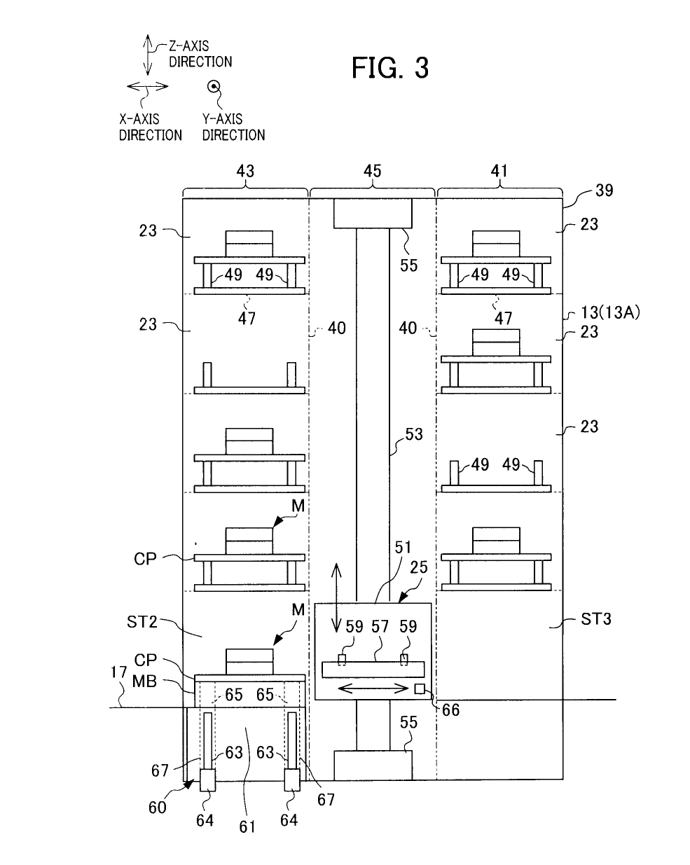

FIG. 3 is an enlarged view of the V portion in FIG. 2, and is a view showing the configuration of the first mold hangar 13A.

The first mold hangar 13A is configured to include a plurality of mold storage rooms (mold stowing locations) 23, a plurality of mold exchanging stations ST2, a mold receiving station ST3, and a stacker crane 25 as a mold transfer device, as shown in FIGS. 1 to 3.

As shown in FIG. 3, the first mold hangar 13A is configured by a frame 39 having a profile formed in a rectangular parallelepiped shape, and the plurality of mold storage rooms 23, the plurality of mold exchanging stations ST2 and the mold receiving station ST3 are respectively formed in rectangular parallelepiped shapes by the inside of this frame 39 being partitioned by partitioning walls 40. This plurality of mold storage rooms 23, plurality of mold exchanging stations ST2, and mold receiving station ST3 are formed to be aligned two-dimensionally in the Y-axis direction and Z-axis direction. In addition, the mold exchanging station ST2 and the mold receiving station ST3 are formed to be the lowest in the Z-axis direction.

The first mold hangar 13A is partitioned into an area 41 on one end side in the X-axis direction in which the plurality of mold storage rooms 23 and the mold receiving station ST3 are provided, an area 43 on another end side in the X-axis direction in which the plurality of mold storage rooms 23 and the plurality of mold exchanging stations ST2 are provided, and a space 45 provided between the area 41 on the one end side and the area 43 on the other end side, and in which the stacker crane 25 is arranged.

It should be noted that, since it is necessary to take the molds M in and out using the stacker crane 25, the faces of the plurality mold storage rooms 23, the plurality of the mold exchanging stations ST2, and the mold receiving station ST3 on the space 45 side are open.

The mold storage rooms 23 store the molds M used in the press machines P1 to P4. It should be noted that one set of molds M composed of one upper mold M1 and one lower mold M2 is stored in one mold storage room 23, without the moving bolster MB.

A plurality (e.g., four) of mold placement bodies 49 formed in a column shape is provided to the bottom surface of the plurality of mold storage rooms 23. The plurality of mold placement bodies 49 are provided to be respectively separated in the X-axis direction and Y-axis direction by a suitable distance. In other words, they are each provided in the vicinity of the four corners of the bottom surface of the mold storage room 23.

The mold M is placed on this plurality of mold placement bodies 49 in a state placed on the common plate CP.

Therefore, in a case of the common plate CP on which the mold M is placed being placed on the respective mold placement bodies 49, the common plate CP and the bottom surface of the mold storage room 23 separate, and the mold support 57 of the stacker crane 25, which is described later in detail, comes to penetrate below the common plate CP.

The mold exchanging stations ST2 are provided to respectively correspond to the press machines P1 to P4, as shown in FIG. 1. In other words, four mold exchanging stations ST2 are provided to the first mold hangar 13A.

The four mold exchanging stations ST2 are respectively disposed on approximately the same axis as the press machines P1 to P4 in the X-axis direction.

In addition, the mold exchanging stations ST2 include a placement stand 61 on which the moving bolster MB to which the mold M is installed is placed, and a mold separating device 60 that causes the mold M installed to the moving bolster MB placed on this placement stand 61 to separate from the moving bolster MB in the Z-axis direction, as shown in FIG. 3.

The top surface of the placement stand 61 configures the bottom surface of the mold exchanging station ST2, and is formed so as to be substantially the same height as the bottom surface on which the press machines P1 to P4 are installed. With this, the moving bolster MB is made to be able to enter the mold exchanging station ST2.

In addition, a hole portion 67 that extends in the Z-axis direction is formed at each of the four corners of the placement stand 61.

The mold separating device 60 includes four mold lifting members 63 provided under the placement stand 61 and formed in a cylindrical shape, and a drive mechanism 64 that advances and retracts the mold lifting member 63 in the Z-axis direction (up-down direction).

The mold lifting member 63 is arranged inside of the hole portion 67 formed in the placement stand 61.

The drive mechanism 64 is configured by an actuator such as a hydraulic cylinder, for example.

The mold receiving station ST3 has an external surface in the X-axis direction that is open, and is configured to be enterable by the mold conveying cart 21.

The mold receiving station ST3 is aligned with the mold storage rooms 23 in the Y-axis direction and Z-axis direction, and provided inside the area 41, which is the area on an opposite side to the press machines P1 to P4.

It should be noted that, although the mold receiving station ST3 is provided at one location for one of the mold hangars 13, it may be provided at a plurality of locations for one of mold hangar 13.

The stacker crane 25 transfers the mold M in the three dimensions.

More specifically, the stacker crane 25 performs transferring of the mold M between a mold exchanging station ST2 and a mold storage room 23. In addition, the stacker crane 25 performs transferring of the mold M between the mold receiving station ST3 and a mold storage room 23.

The stacker crane 25 is arranged in the space 45 and includes a main body portion 51, a first guide rail 53, a second guide rail 55, and a mold support 57, as shown in FIG. 3.

Two of the second guide rails 55 are provided, for example, with one extending in the Y-axis direction at the top part of the space 45 and being integrally provided in the frame 39, and the other one extending in the Y-axis direction at the bottom part of the space 45 and being integrally provided in the frame 39.

The first guide rail 53 is formed to extend inside of the space 45 in the Z-axis direction. An upper end portion of the first guide rail 53 engages with an upper side of the second guide rail 55 via a linear guide bearing that is not illustrated, and a lower end portion of the first guide rail 53 engages with the lower side of the second guide rail 55 via a linear guide bearing that is not illustrated. In addition, the first guide rail 53 is configured to freely undergo mobile positioning relative to the frame 39 in the Y-axis direction (direction of the arrow A2 in FIG. 1), by using an actuator such as a servo motor, a rack and pinion, and the like, which are not illustrated.

The main body portion 51 engages the first guide rail 53 via a linear guide bearing that is not illustrated. In addition, the main body portion 51 is configured to freely undergo mobile positioning relative to the first guide rail 53 in the Z-axis direction, by using an actuator such as a servo motor, a rack and pinion, and the like, which are not illustrated.

The main body portion 51 is thereby configured to freely undergo mobile positioning inside the space 45 in the Y-axis direction and the Z-axis direction.

The mold support 57 is a member on which the common plate CP on which the mold M is placed is placed, engages with the main body portion 51 via a linear guide bearing that is not illustrated, and is configured to be movable in the X-axis direction by using an electric or hydraulic actuator that is not illustrated.

The mold support 57 is made in a telescoping structure, and is configured so as to project from the main body portion 51 into the mold storage rooms 23 (into a space existing between each mold placement body 49, which is a space on a lower side of the common plate CP), in a case of being placed on the common plate CP, etc. present in the mold storage room 23 (common plate CP on which the mold M is placed).

In addition, the mold support 57 is configured so as to fit into the main body portion 51 in a state in which the common plate CP, etc. are placed thereon. Then, the main body portion 51 is configured to freely undergo mobile positioning in the Y-axis direction and Z-axis direction inside of the space 45, in a state in which the mold support 57 has the common plate CP, etc. placed thereon and fits into the main body portion 51.

It should be noted that, since the mold storage rooms 23 are provided to be partitioned on both the left and right sides of the space 45, the mold support 57 is configured so as to project in the direction of either right or left from the state shown in FIG. 3.

A plurality of placement pins 59 is provided to the mold support 57. Each of the placement pins 59 is configured to stroke in the Z-axis direction to project and retract from a top surface of the mold support 57 by way of a hydraulic cylinder 66 provided to the main body portion 51. Each of the placement pins 59 is provided at a position separated in the X-axis direction and the Y-axis direction by a suitable distance and corresponding to a corner of a quadrangle.

Except for the second mold hangar 13B being configured axisymmetrically with the conveyor line of works as the axis of symmetry, it has a similar configuration to the first mold hangar 13A.

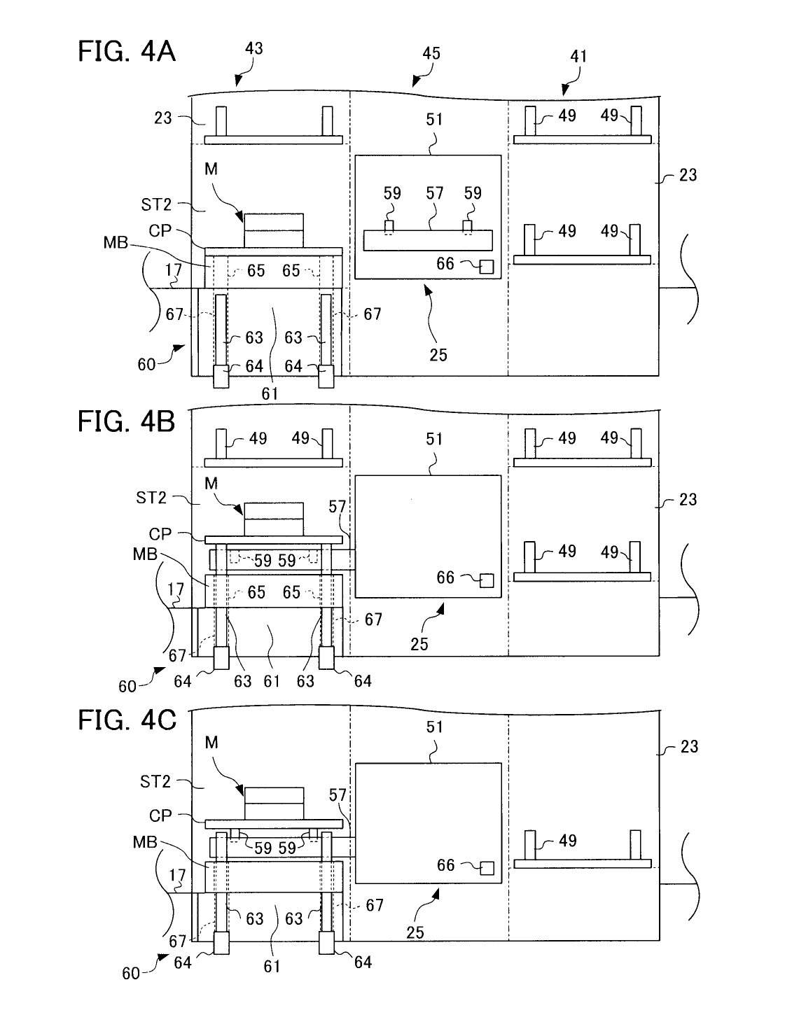

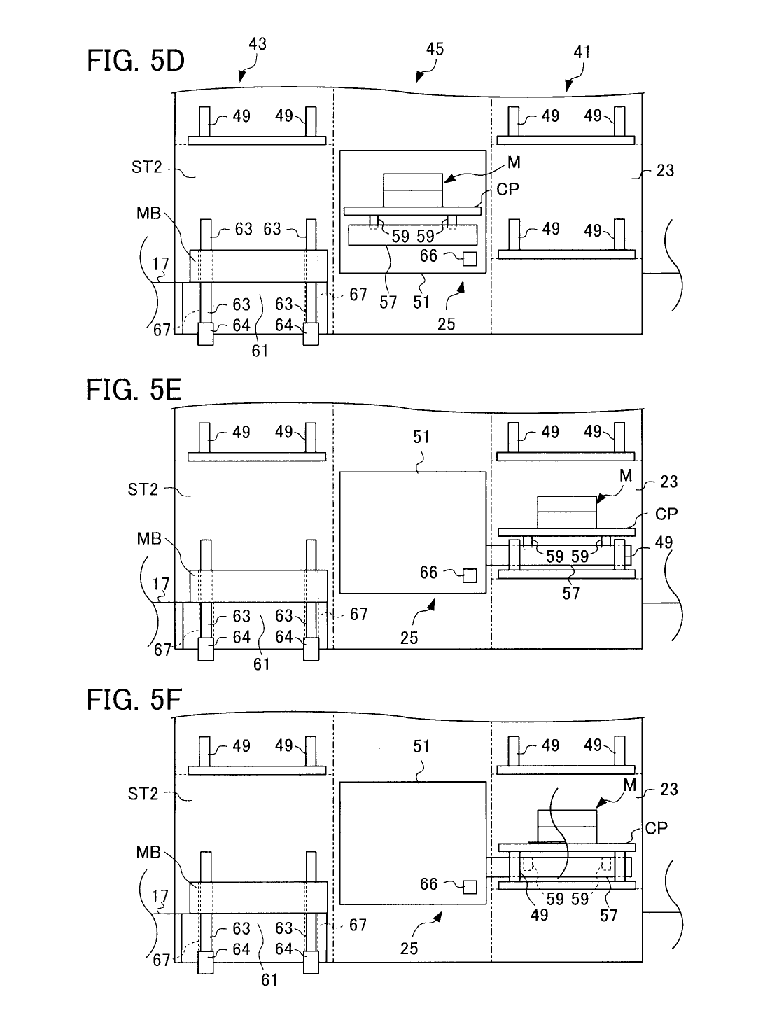

Next, operations in a case of transferring the mold M in the mold exchanging station ST2 will be explained while referring to FIGS. 4 and 5.

FIGS. 4A to 4C and FIGS. 5D to 5F are respectively diagrams showing each step in a case of transferring the mold M in the mold exchanging station ST2.

First, the moving bolster MB is taken into the mold exchanging station ST2 in a state in which the mold M is installed on a top surface via the common plate CP, as shown in FIG. 4A.

In this state, the plurality of mold lifting members 63 is positioned below the placement stand 61.

Next, the drive mechanism 64 is driven to raise the plurality of mold lifting members 63. When this is done, the mold lifting members 63 pass through penetrating holes 65 provided in the moving bolster MB and lifts the common plate CP, etc. (common plate CP placing the mold M thereon) placed on this moving bolster MB.

In this state, the common plate CP separates upward from the moving bolster MB present in the mold exchanging station ST2.

Next, the main body portion 51 of the stacker crane 25 is made to stop at a suitable position, and the mold support 57 is made to extend from the main body portion 51 to the mold exchanging station ST2 side (between the moving bolster MB and the common plate CP, etc.), as shown in FIG. 4B. In this state, the plurality of placement pins 59 fits inside of the mold support 57 without leaving the top surface of the main body portion 51.

Next, the plurality of placement pins 59 is made to project from the top surface of the main body portion 51 in a state in which the mold support 57 is extended to the mold exchanging station ST2 side, as shown in FIG. 4C. When this is done, the common plate CP and the mold M are lifted by the plurality of placement pins 59, whereby the common plate CP separates from the mold lifting members 63.

Next, the mold support 57 is stored in the main body portion 51 in a state in which the common plate CP and the mold M are lifted by the plurality of placement pins 59, as shown in FIG. 5D. The common plate CP and the mold M placed on the mold support 57 via the placement pins 59 are thereby stored in the main body portion 51.

Next, in a state in which the common plate CP and the mold M are stored in the main body portion 51, the main body portion 51 is moved to the position of an appropriate mold storage room 23 to store the common plate CP and the mold M, and the mold support 57 is made to extend to the mold storage room 23 side. When this is done, the mold support 57 penetrates between the plurality of placement bodies 49 provided to the appropriate mold storage room 23. In this state, the common plate CP separates upwards from the plurality of mold placement bodies 49.

Next, in a state in which the common plate CP has separated upward from the plurality of mold placement bodies 49, the plurality of placement pins 59 is made to descend to be stored inside the mold support 57, as shown in FIG. 5F. When this is done, the common plate CP and the mold M descend and are supported on the plurality of mold placement bodies 49.

It should be noted that transferring of the mold M and the common plate CP from the mold storage room 23 to the moving bolster MB disposed in the mold exchanging station ST2 is done by the reverse operation to the aforementioned operation by the stacker crane 25.

Next, operation in a case of transferring the mold M to the mold conveying cart 21 of the mold receiving station ST3 will be explained while referring to FIG. 6.

FIGS. 6A to 6C are respectively diagrams showing each step in a case of transferring the mold M in the mold receiving station ST3 to the mold conveying cart 21.

An electric train and automated guided vehicle (AGV) that can move by remote control can be exemplified as specific examples of the mold conveying cart 21.

First, the mold conveying cart 21 on which the mold M and common plate CP are not placed is taken into the mold receiving station ST3 provided inside the mold hangar 13, as shown in FIG. 6A.

In this state, the common plate CP and mold M placed on the mold support 57 via the placement pins 59 are transferred to a position corresponding to the mold receiving station ST3 inside the main body portion 51.

Next, in a state in which the mold support 57 on which the common plate CP and the mold M are placed is disposed inside the main body portion 51, this mold support 57 is extended to the mold receiving station ST3 side, as shown in FIG. 6B. When this is done, the mold support 57 penetrates between the plurality of mold placement bodies 49 provided to the top surface of the mold conveying cart 21. In this state, the common plate CP being supported on the plurality of placement pins 59 separates upward from the plurality of mold placement bodies 49.

Next, in a state in which the common plate CP is separated upward from each mold placement body 49, the plurality of placement pins 59 is made to descend to be stored inside the mold support 57, as shown in FIG. 6C. When this is done, the common plate CP and the mold M descend and are supported on the plurality of mold placement bodies 49. The common plate CP and the mold M are thereby placed on the mold conveying cart 21.

It should be noted that the transferring of the mold M and the common plate CP from the mold conveying cart 21 to the mold storage room 23 is done by the reverse operation to the aforementioned operation.

The following effects are exerted according to the present embodiment.

According to the press working system 1, two self-propelled moving bolsters MB are disposed for one press machine. The discharging directions of the molds M from the press machines P1 to P4 are distributed between left and right. Consequently, so long as the processes such as storing the mold M in the mold hangar 13 are allotted substantially half and half to the sides of the left and right direction, respectively, the time for off-line setup of the mold M can be shortened.

Furthermore, the possibility of a situation arising in which press working by the press machines P1 to P4 must be temporarily interrupted can be avoided as much as possible, even if the exchange frequency of the mold M is raised.

In addition, according to the press working system 1, the discharging direction of each mold M from each press machine P1 to P4 is divided to left and right, and each of the mold hangars 13A and 13B are provided at the divided ends, respectively. With this, it is possible to increase the number and types of molds M that can be stored, as well as to reduce the burden on the stacker crane 25 provided to each of the mold hangars 13A and 13B. Consequently, idle running of the stacker crane 25 and the distance travelled of the stacker crane 25 can be reduced to shorten the mold exchanging time, which can contribute to energy conservation.

In addition, according to the press working system 1, the mold M can be supplied from an opposite direction than the discharging direction of molds M in the press machines P1 to P4. The down time of the press machines P1 to P4 can thereby be shortened when exchanging molds M.

In addition, according to the press working system 1, the mold M and moving bolster MB can be conveyed between the press machines P1 to P4 and the mold hangars 13 without specially providing ancillary equipment such as a traverser. It is thereby possible to shorten times such as the time to hand over the mold M with the traverser and the travelling time of the traverser. Consequently, since the conveying time of the mold M between the press machines P1 to P4 and the mold hangar 13 can be shortened, the exchanging time of a mold in accordance with a change in the work being manufactured can be drastically shortened.

In addition, according to the press working system 1, the configuration of the press working system 1 is simplified since the traverser is eliminated. The production cost of the press working system 1, running cost, and maintenance cost can thereby be reduced. In addition, the space occupied by the press working system 1 can be reduced.

Moreover, conveyance has been made to be automated by the mold conveying cart 21 between the mold hangars 13 and the mold maintenance area 37. The maintenance time of the molds M can thereby be drastically shortened.

In addition, the molds M are directly handed over between the mold hangars 13 and the mold conveying cart 21 without using ancillary equipment such as an overhead crane. Consequently, the conveying time of molds M between the mold hangars 13 and the mold maintenance area 37 can be shortened.

In addition, since ancillary equipment such as an overhead crane is unnecessary, the configuration of the mold conveying system 33 is simplified, and the production cost of the mold conveying system 33, running cost, and maintenance cost can be reduced. Moreover, the space occupied by the press working system 1 can be reduced.

Furthermore, since placement of the mold M on the mold conveying cart 21 and carrying out of the mold M from the mold conveying cart 21 is done using the stacker cranes 25 provided to the mold hangars 13, the configuration of the mold conveying cart 21 can be simplified.

It should be noted that the present invention is not to be limited to the embodiment, and modifications, improvements, and the like within a scope that can achieve the objects of the present invention are included in the present invention.

For example, although the press working system 1 has been configured by four press machines in the present embodiment, it may be configured by a plurality of press machines other than four. In addition, although the discharge direction and supply direction of the molds M change alternately in each press machine P1 to P4, the discharge direction and supply direction of the molds may be defined as the right direction in any few of the press machines among the respective press machines P1 to P4, and the discharge direction and supply direction may be defined as the left direction in the other respective press machines.

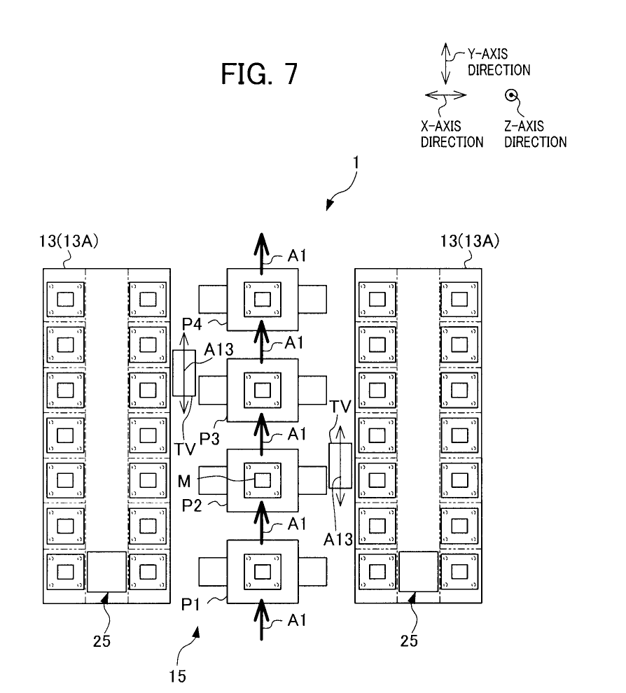

Moreover, although a traverser is made obsolete in the present embodiment, transfer of the molds M, common plate CP, and moving bolster MB between the press machines P1 to P4 and the mold hangars 13 may be performed using a traverser TV that can undergo mobile positioning in the Y-axis direction (direction indicated by the arrow A13), as shown in FIG. 7.

Furthermore, although the exchanging of each mold M is configured to be done when the works have been discharged from all of the press machines P1 to P4 in the present embodiment, it may be configured so as to carry out the exchanging of molds M in order from a press machine in which the processing of a final work among a predetermined type of work group has finished (e.g., sequentially perform the exchanging of molds M by configuring so as to carry out the exchanging of the mold M of the press machine P2 after the exchanging of the mold M of the press machine P1 has completed), and start the processing of an initial work among a subsequent predetermined type of work group in order from a press machine in which the exchanging of the mold M was finished. It is possible to greatly shorten the down time of the respectively press machines P1 to P4 by configuring in this way.

In addition, although a case of installing a plurality of press machines has been given and explained in the present embodiment, it may be a configuration in which multiple molds of one press machine (press device) are established.

1. A press working system including:
a press main body having a plurality of press machines that press work a plate member to produce an industrial product; and
a moving bolster that causes a mold equipped inside of each of the plurality of press machines to move and be stored in a mold hangar,
wherein the mold hangar is disposed as a pair at both sides of the press main body about a longitudinal direction thereof.

2. The press working system according to claim 1, wherein a pair of the mold hangars has a plurality of mold storage rooms that three-dimensionally stores a plurality of molds.

3. The press working system according to claim 1, wherein a pair of the mold hangars has a stacker crane at a center inside thereof that is movable in two dimensions, and have a structure in which a plurality of mold storage rooms is disposed two-dimensionally on both sides about the stacker crane.

4. The press working system according to claim 1, wherein the mold moves between inside of the press machine and inside the mold hangar in a state installed on the moving bolster.

5. press working system including a press main body having a plurality of press machines that press work a plate member to produce an industrial product, and
having a configuration that causes molds provided inside of the plurality of press machines to move and stores the mold in a mold hangar,
wherein, when the mold is stored in the mold hangar or carried out therefrom, a mold conveying cart is made to directly enter inside of the mold hangar, to store the mold inside of the mold hangar or to carry the mold out from the mold hangar.

6. The press working system according to claim 5, wherein the mold hangar has a plurality of mold storage rooms that stores a plurality of molds three-dimensionally.

7. The press working system according to claim 5, wherein transfer of the mold between the mold conveying cart and the mold hangar is performed by a stacker crane disposed inside of the mold hangar.

8. The press working system according to claim 7, wherein the stacker crane has a function of being able to freely transfer the mold into a plurality of mold storage rooms disposed three-dimensionally at a periphery of the stacker crane.

9. A press working system including a press machine that conducts press working on a work using a mold installed on a moving bolster, and
a mold hangar that can store a plurality of molds,
wherein the press working system comprises a mechanism that allows a mold and moving bolster used in the press machine to freely move between inside of the mold hangar and the press machine, and a mold separating device causing the mold and the moving bolster to separate is provided inside of the mold hangar.

10. The press working system according to claim 9, wherein a mold transfer device that can change a storage position of a mold three-dimensionally is provided to the mold hangar.

11. The press working system according to claim 9, wherein the mold separating device has a mold lifting member that operates in an up-down direction by way of hydraulics or electric power.

12. The press system according to claim 9, wherein at least two self-propelled moving bolsters are disposed to be able to enter and exit from the press machine.
